(19) United States
(12) Patent Application Publication
(10) Pub. No.: US 2026/0208593 A1
(43) Pub. Date: Jul. 23, 2026

(54) ENERGY DISCHARGE SYSTEM TO PREVENT THERMAL RUNAWAY IN A LOCOMOTIVE

(71) Applicant: Progress Rail Locomotive Inc., LaGrange, GA (US)

(72) Inventor: Andrew Quinn, Leonay (AU)

(73) Assignee: Progress Rail Locomotive Inc., LaGrange, GA (US)

(21) Appl. No.: 19/188,180

(22) Filed: Apr. 24, 2025

Related U.S. Application Data
(60) Provisional application No. 63/748,775, filed on Jan. 23, 2025.

(51) Int. Cl. B60L 3/00; B60L 58/25

(52) U.S. Cl. CPC B60L 3/0046; B60L 58/25; B60L 2200/26

(57) ABSTRACT

When there is an event that could result in a thermal runaway, a battery system of a locomotive discharges the battery energy into a dynamic brake grid of the locomotive. Discharging the battery energy into the dynamic brake grid is expected to significantly affect the sequence of events in a thermal runaway as the time required to discharge the energy is similar. Circumstances that would trigger the discharge include significant locomotive collision or impact, overcharging or overvoltage, under voltage (which is an indication of battery cell failure), overcurrent in a specific string, over temperature alarm, cell venting detection, or smoke or heat detection.

### CLAIM OF PRIORITY

This application claims the benefit of U.S. Provisional Patent Application Ser. No. 63/748,775, filed on Jan. 23, 2025, the benefit of priority of which is claimed hereby, and which is incorporated by reference herein in its entirety.

### FIELD OF THE DISCLOSURE

This document pertains generally, but not by way of limitation, to battery electric and hybrid machines and, more particularly, to battery systems for battery powered locomotives.

### BACKGROUND

Battery electric machines are a type of electric vehicle that rely solely on electric power stored in a battery module to propel and operate the machine. Unlike hybrid vehicles that combine internal combustion engines with electric motors, battery electric machines operate entirely on electricity, making them an environmentally friendly alternative to gasoline or diesel-powered machines. These machines utilize electric motors powered by high-capacity battery modules, which provide the necessary energy to drive the vehicle's traction system, such as including wheels and/or tracks.

Battery modules are the heart of battery electric and hybrid machines. They are composed of multiple individual battery cells, such as lithium-ion or lithium-polymer, which store electrical energy chemically. These cells are interconnected and packaged together in a compact and robust unit, ensuring efficient energy storage and delivery. The size and capacity of battery modules vary depending on the specific machine and its intended use. Higher-capacity battery modules allow battery electric machines to operate longer on a single charge.

DE102020104616 describes an energy storage arrangement comprising at least one energy storage module with at least two electrical energy storage cells, in particular an energy storage arrangement for a motor vehicle. The energy storage arrangement has a detection device designed to detect a thermal event occurring in one of the energy storage cells of the energy storage arrangement, where a discharge device is designed to at least partially discharge at least one energy storage cell which is directly or indirectly coupled to the energy storage cell in which the thermal event occurs.

### SUMMARY OF THE DISCLOSURE

Using various techniques of this disclosure, when there is an event that could result in a thermal runaway, a battery system of a locomotive discharges the battery energy into the dynamic brake grid of the locomotive. A cascading thermal runaway process is expected to occur over a period of several hours in a typical locomotive or large mining machine battery system. Discharging the battery energy into the dynamic brake grid is expected to significantly affect the sequence of events in a thermal runaway as the time required to discharge the energy is similar. Circumstances that would trigger the discharge include significant locomotive collision or impact, overcharging or overvoltage, under voltage (which is an indication of battery cell failure), overcurrent in a specific string, over temperature alarm, cell venting detection, or smoke or heat detection. Discharge may occur automatically or by driver initiation.

In some aspects, this disclosure is directed to an energy discharge system for preventing thermal runaway in a locomotive, wherein the locomotive has a dynamic brake grid including at least one resistor bank, the energy discharge system comprising: a plurality of battery strings coupled with a power supply rail, wherein each battery string includes a battery module having a battery cell; a plurality of cell monitoring units associated with corresponding battery modules; a battery management system in communication with the plurality of cell monitoring units, wherein the cell monitoring units are configured for: determining a parameter of the battery cell in the battery module; transmitting a representation of the parameter to the battery management system; and wherein the battery management system is configured for: receiving, from the cell monitoring units, the representation of the parameter of the battery cell; and in response to the representation of the parameter deviating from a threshold value: decoupling, from the power supply rail, the battery string associated with the battery cell; and for at least one of the battery strings still coupled to the power supply rail, coupling the at least one battery string to the dynamic brake grid to dissipate at least a portion of the energy stored in the at least one battery string.

In some aspects, this disclosure is directed to a method for preventing thermal runaway in a locomotive, wherein the locomotive has a dynamic brake grid including at least one resistor bank, wherein the locomotive has a battery system including a plurality of battery strings coupled with a power supply rail, wherein each battery string includes a battery module having a battery cell, a plurality of cell monitoring units associated with a corresponding battery module, and a battery management system in communication with the plurality of cell monitoring units, the method comprising: determining a parameter of the battery cell in the battery module; transmitting a representation of the parameter to the battery management system; receiving, from the cell monitoring units, the representation of the parameter of the battery cell; and in response to the representation of the parameter deviating from a threshold value: decoupling, from the power supply rail, the battery string associated with the battery cell; and for at least one of the battery strings still coupled to the power supply rail, coupling at least one battery string to the dynamic brake grid to dissipate at least a portion of the energy stored in the at least one battery string.

In some aspects, this disclosure is directed to an energy discharge system for preventing thermal runaway in a locomotive, wherein the locomotive has a dynamic brake grid including at least one resistor bank, the energy discharge system comprising: a plurality of battery strings coupled with a power supply rail, wherein each battery string includes a battery module having a battery cell; a plurality of cell monitoring units associated with corresponding battery modules; a battery management system in communication with the plurality of cell monitoring units, wherein the battery management system is configured for: receiving, from the cell monitoring units, a representation of a parameter of the battery cell; and in response to the representation of the parameter deviating from a threshold value: decoupling, from the power supply rail, the battery string associated with the battery cell; and for at least one of the battery strings still coupled to the power supply rail, coupling the at least one battery string to the dynamic brake grid to dissipate at least a portion of the energy stored in the at least one battery string.

### BRIEF DESCRIPTION OF THE DRAWINGS

In the drawings, which are not necessarily drawn to scale, like numerals may describe similar components in different views. The drawings illustrate generally, by way of example, but not by way of limitation, various embodiments discussed in the present document.

FIG. 1 illustrates an example of a locomotive that may implement various techniques of this disclosure.

FIG. 2 is a simplified schematic diagram of an example of a portion of a battery system of a locomotive.

FIG. 3 is a simplified schematic diagram of an example of a portion of an energy discharge system that may implement various techniques of this disclosure.

FIG. 4 is a simplified block diagram of an example of the energy discharge system of FIG. 3 in combination with a load and a dynamic brake grid of a locomotive.

FIG. 5 is a flow diagram of an example of a method for preventing thermal runaway in a locomotive in accordance with this disclosure.

### DETAILED DESCRIPTION

Lithium-ion batteries are susceptible to thermal runaway and fire. Thermal runaway may cause serious property damage, among other things. Thermal runaway may be initiated by mechanical, thermal, or electrical abuse of the batteries or may occur due to manufacturing defects or degradation of the battery due to aging. Depending on the mechanism causing the thermal runaway, it is possible to detect the process early and intervene. Cell voltage, current, and/or temperature may be monitored for detection purposes. The heat release rate and the total energy released during thermal runaway are dependent upon the battery state of charge (SoC), and this is the reason that batteries are transported at a low state of charge prior to installation in a machine.

Locomotive batteries are configured with strings of battery modules. Each string is made up of a number of battery modules connected in series, and each battery module contains a number of battery cells connected in series or parallel. Intervention to prevent thermal runaway typically involves removing the electrical load from the affected string. When a single module undergoes thermal runaway due to any cause, the adjacent cells in the module and the adjacent modules may overheat, which may cause cascading thermal runaway in the entire battery system and, in some instances, the total loss of the machine. Since the heat release rate and the total energy released during a thermal runaway is dependent on the state of charge of the cells involved, the probability of cascading thermal runaway increases with the state of charge of the battery cells.

The present inventor has recognized the problem of managing a battery to maximize safety during the operation of the machine and to prevent cascading thermal runaway if a single module does experience thermal runaway. The present inventor has recognized the desirability of discharging the energy storage in the battery in circumstances in which the battery system may be exposed to high temperatures and the risk of a thermal runaway. Using various techniques of this disclosure, when there is an event that could result in a thermal runaway, a battery system of a locomotive discharges the battery energy into the dynamic brake grid of the locomotive. A cascading thermal runaway process is expected to occur over a period of several hours in a typical locomotive or large mining machine battery system. Discharging the battery energy into the dynamic brake grid significantly affects the sequence of events in a thermal runaway as the time required to discharge the energy is similar. Circumstances that would trigger the discharge include significant locomotive collision or impact, overcharging or overvoltage, under voltage (which is an indication of battery cell failure), overcurrent in a specific string, over temperature alarm, cell venting detection, or smoke or heat detection. Discharge may occur automatically or by driver initiation.

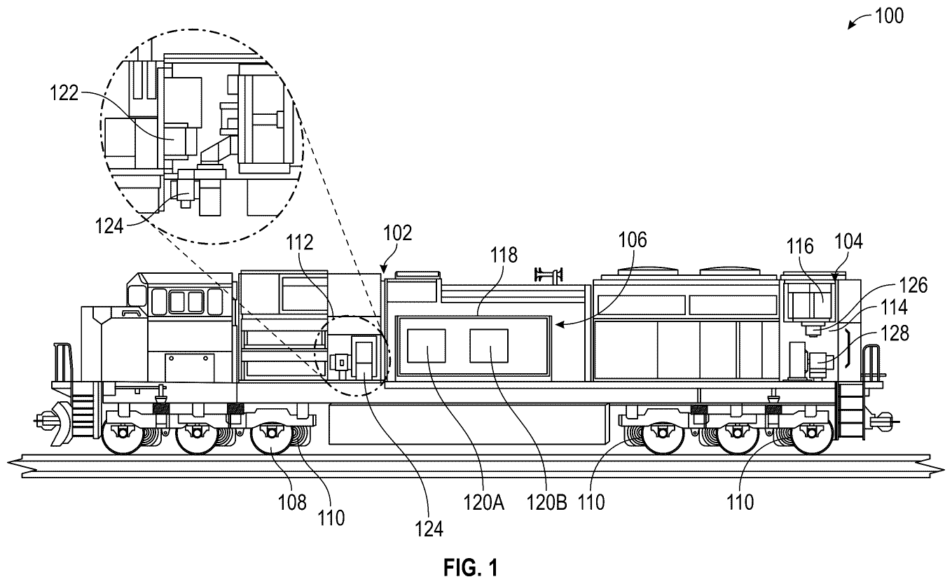

FIG. 1 illustrates an example of a locomotive 100 that may implement various techniques of this disclosure. The locomotive 100 may include a dual-fueled electric locomotive. The locomotive 100 may include single locomotive, multiple locomotives, a train moved by single locomotive, a train moved by multiple locomotives and any other arrangement of locomotives.

As shown in FIG. 1, the locomotive 100 may include a first compartment 102, a second compartment 104, a power compartment 106, at least one wheel 108, at least one traction motor 110, a front air inlet 112, a rear air inlet 114, and at least one electrical component. The traction motor 110 may drive the wheel 108. The electrical component may be any component associated with an electric traction system (not shown) of the locomotive 100 and generating heat. In some examples, the electrical component may include the traction motor 110, a generator (not shown), a dynamic brake grid 116, an electrical locker (not shown), or other such components.

As seen in FIG. 1, the second compartment 104 may include the dynamic brake grid 116. The dynamic brake grid 116 may include a plurality of resistors for converting electrical power generated during dynamic braking into heat. The dynamic brake grid 116 includes high-resistance resistor grids and is a component of the dynamic braking system. The dynamic brake grid 116 helps slow down the locomotive 100 by converting kinetic energy into electrical energy and then dissipating that energy as heat. Dynamic braking is especially useful for controlling speed on long downhill grades, helping to prevent overheating of traditional friction brakes.

The power compartment 106 may include at least one battery pack 118. The battery pack 118 includes a plurality of battery strings, shown as battery string 120A and battery string 120B. Each battery string includes a plurality of battery modules, where each battery module includes a plurality of battery cells. When the locomotive 100 is in operation, the battery pack 118 provides electrical energy directly to various components, including the traction motor 110, which drives the wheels 108. The traction motor 110 receives a controlled flow of power to generate sufficient torque to move the train forward or in reverse.

The first compartment 102 and the second compartment 104 may include at least one fan. In some examples, the fan may include a first traction fan 122, a generator fan 124, a dynamic brake grid fan 126, a second traction fan 128, an electrical locker fan (not shown), and a radiator fan (not shown). The first traction fan 122 and the generator fan 124 may be placed in the first compartment 102. The dynamic brake grid 116, the dynamic brake grid fan 126, and the second traction fan 128 may be placed in the second compartment 104.

The first traction fan 122 and the second traction fan 128 may direct an air flow towards the traction motor 110 for cooling. The generator fan 124 may direct an air flow towards the generator (not shown) for cooling. The dynamic brake grid fan 126 may direct an air flow towards the dynamic brake grid 116 for cooling. The electrical locker fan (not shown) may direct an air flow towards the electrical locker (not shown) for cooling. The radiator fan (not shown) may direct an air flow towards a radiator (not shown) for cooling.

As described in more detail below and in accordance with this disclosure, when there is an event that could result in a thermal runaway, a battery system of a locomotive, such as including the battery pack 118, decouples, e.g., disconnects, a battery string with a faulty battery cell and discharges the battery energy of any remaining healthy battery string(s) into the dynamic brake grid 116 of the locomotive 100.

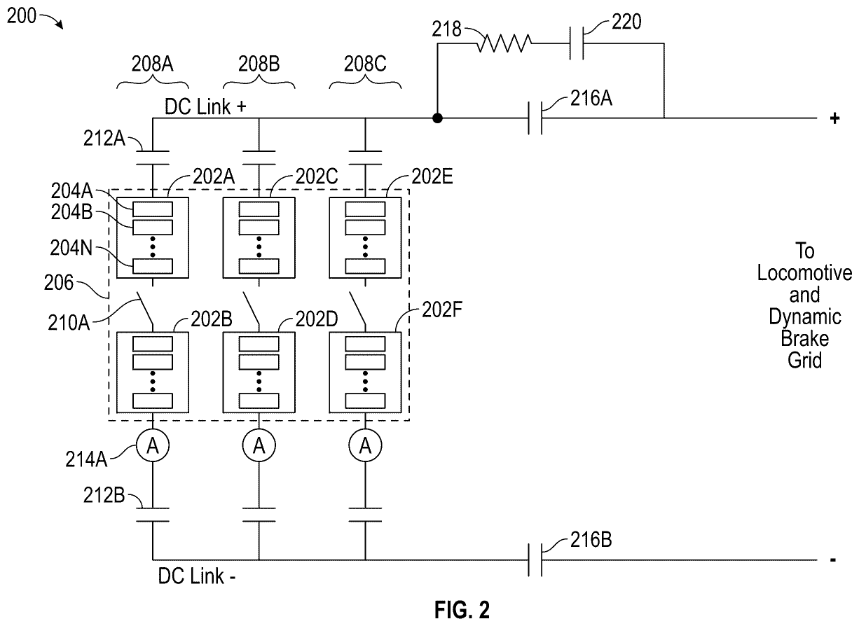

FIG. 2 is a simplified schematic diagram of an example of a portion of a battery system 200 of a locomotive. The battery system 200 includes one or more battery modules 202A-202F that together form a battery pack, such as the battery pack 118 of FIG. 1. A battery module, such as the battery module 202A, may include one or more battery cells 204A-204N. Battery modules may be coupled together to form a battery pack. For example, the battery modules 202A-202F may be coupled together to form a battery pack 206.

The battery modules may be arranged in battery strings. For example, the battery modules 202A, 202B may be coupled in series to form a first battery string 208A. The battery modules 202C, 202D and the battery modules 202E, 202F may be similarly coupled to form a second battery string 208B and a third battery string 208C, respectively. In other examples, one or more of the battery strings includes more than two battery modules. The battery strings are coupled between the power supply rails, shown as DC Link+and DC Link-.

The battery strings may include a manual disconnect switch toward or at the middle of a string. For example, the string 208A may include a manual disconnect switch 210A between the battery module 202A and the battery module 202B.

In some examples, the battery strings may include a first contact 212A and a second contact 212B, where the first contact 212A and the second contact 212B are contact coupled between a battery module and the locomotive 100. The first contact 212A and the second contact 212B may form part of a contactor that includes an operating coil and contacts that are actuated when the operating coil is energized or deenergized. By including the first contact 212A and the second contact 212B, for example, the first battery string 208A may be isolated from the remaining battery strings 208B, 208C, such as during a fault condition.

In the example shown in FIG. 2, each battery string may include a current sensor, such as the current sensor 214 of the string 208A, to sense the current through the string. Although depicted as being located on the negative side of the battery string, the current sensor 214 may alternatively be located on the positive side of the battery string. In some examples, each battery string may include a fuse.

The battery strings 208A-208C may be coupled in parallel, such as to increase the capacity available to the electrified machine 100 of FIG. 1. A non-limiting list of examples of components (or loads) that may be connected to the battery system 200 of FIG. 2 and battery powered include one or more of the fans described below and an A/C compressor.

The battery system 200 may be coupled to the locomotive 100 via contacts 216A, 216B. In some examples, it may be desirable to include a resistor 218 coupled in series with a contact 220, where the resistor 218 and the contact 220 are coupled in parallel with the contact 216A. The resistor 218 may be a precharge resistor to control a flow of current from the battery modules 202A-202F.

The battery system 200 may include a sensor 222A configured to sense a representation of an electrical parameter of the battery modules 202A-202F. The sensor 222A may be coupled to a first side of the contact 216A. For example, the sensor 222A may be a voltage sensor configured to sense a representation of a voltage across the battery pack 206. The sensor 222A may measure a voltage, for example, at the terminals of the battery pack 206.

In some examples, the battery system 200 may include a sensor 222B configured to sense an electrical parameter of the battery modules 202A-202F. The sensor 222B may be coupled to a second side of the contact 216A and configured to sense the electrical parameter of the at least one battery module as seen by the machine. For example, the sensor 222B may be a voltage sensor configured to sense a voltage across the battery pack 206, as seen by the electrified machine 100 of FIG. 1. In some examples, the sensor 222B is used to determine a precharge level. Essentially, the battery system 200 may monitor the battery side voltage with the sensor 222A, then during precharge, the sensor 222B may indicate how the machine side capacitance is charging. The battery system 200 will not close the +main contactor until both voltages are within a certain voltage of each other.

As described in more detail below, in the event that there is a fault in one of the battery cells, such as the battery cell 204A in the battery module 202A in the battery string 208A, the present inventor has recognized the desirability of decoupling, e.g., disconnecting, the battery string 208A from the power supply rail DC Link +, and for one or more of the battery strings still coupled to the power supply rail, e.g., battery string 208B and battery string 208C, coupling the one or more battery strings to the dynamic brake grid, e.g., dynamic brake grid 116 of FIG. 1, to dissipate at least a portion of the energy stored in the those battery strings. In this manner, thermal runaway may be prevented by isolating the battery string having the faulty battery cell from any remaining battery strings and by discharging those remaining battery strings.

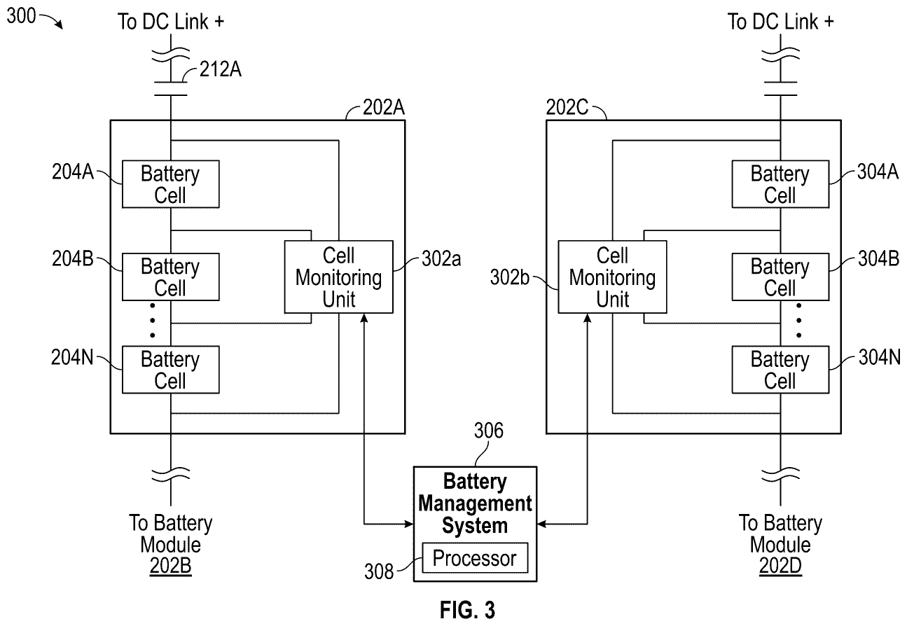

FIG. 3 is a simplified schematic diagram of an example of a portion of an energy discharge system 300 that may implement various techniques of this disclosure. The energy discharge system 300 may form part of the battery system 200 of FIG. 2.

The battery module 202A (of battery string 208A of FIG. 2) is shown in more detail in FIG. 3. As seen in FIG. 3, a cell monitoring unit 302a is associated with the battery module 202A. The cell monitoring unit 302a is coupled across each of the battery cells 204A-204N in the battery module 202A and configured to determine a parameter of one or more of the battery cells in the battery module, such as one or more of a voltage of a battery cell, a current through a battery cell, and a temperature of a battery cell.

The battery module 202C (of battery string 208B of FIG. 2) is shown in more detail in FIG. 3. A cell monitoring unit 302b is associated with the battery module 202C. The cell monitoring unit 302b is coupled across each of the battery cells 304A-304N in the battery module 202C and configured to determine a parameter of one or more of the battery cells in the battery module, such as one or more of a voltage of a battery cell, a current through a battery cell, and a temperature of a battery cell.

The energy discharge system 300 includes a battery management system 306 having a processor 308 configured to execute instructions that perform the various functions ascribed to the battery management system 306 in this disclosure. The battery management system 306 is in communication with the cell monitoring units of the energy discharge system 300, such as the cell monitoring unit 302a and the cell monitoring unit 302b. The cell monitoring units are configured to transmit a representation of the parameter to the battery management system 306, such as data representing one or more of the voltage, the current, or the temperature of one or more of the battery cells in a battery module. The battery management system 306 monitors one or more of these parameters that may indicate or predict thermal runaway conditions, allowing the energy discharge system 300 to take preventive action.

The battery management system 306 is configured to receive the representations of the parameter(s) from the cell monitoring units and compare the received parameter(s) to a corresponding threshold value. In response to the representation of the parameter deviating from a threshold value, e.g., above or below the threshold value (as appropriate), the battery management system 306 is configured to decouple, from the power supply rail, the battery string associated with the battery cell where the representation of the parameter deviates from the threshold value. For example, if the battery management system 306 determines that one or more parameters associated with the battery cell 204B of the battery module 202A deviate from a corresponding threshold value, the battery management system 306 opens first contact 212A to decouple the battery module 202A from the DC Link+ node.

In addition, for one or more of the battery strings still coupled to the power supply rail, the battery management system 306 is configured to couple those remaining battery strings to the dynamic brake grid of the locomotive to dissipate at least a portion of the energy stored in the battery string(s). For example, the battery management system 306 couples the battery string 208B and the battery string 208C of FIG. 2 to the dynamic brake grid 116 of FIG. 1 to dissipate at least a portion of the energy stored in those battery strings to prevent thermal runaway.

In some examples, the battery management system 306 is configured to determine a difference between the representation of the parameter of the battery cell in a first one of the battery modules, such as the battery module 202A, and a representation of the parameter of a battery cell in a second one of the battery modules, such as the battery module 202B. Then, the battery management system 306 determines whether the difference, e.g., a “delta”, deviates from a threshold value. For example, for two healthy battery cells in two different battery modules, the battery management system 306 expects the difference of a parameter, e.g., voltage, between two battery cells of two different battery modules to be low. If the difference deviates from a threshold value, the battery management system 306 determines that there is an unusual condition with one of the battery cells.

In some examples, the battery management system 306 couples the remaining battery strings by selecting, based on their physical proximity to the decoupled battery string, the remaining battery string(s) to couple to the dynamic brake grid. For example, the battery management system 306 couples the battery string 208B of FIG. 2 to the dynamic brake grid because it is closest in physical proximity to the decoupled battery string 208A. Then, the battery management system 306 selects any remaining battery strings still coupled, e.g., still connected, to the power supply rail in an order based on their physical proximity to the decoupled battery string. For example, the battery management system 306 couples the battery string 208C of FIG. 2 to the dynamic brake grid because it is the next closest in physical proximity to the decoupled battery string 208A, and so forth for any other connected battery strings.

In some examples, the battery management system 306 couples the remaining battery string by selecting, selecting the battery string(s) that are physically adjacent to the decoupled battery string. For example, the battery management system 306 couples the battery string 208B of FIG. 2 to the dynamic brake grid because it is physically adjacent to the decoupled battery string 208A.

In some examples, in response to the representation of the parameter deviating from the threshold value and in addition to coupling one or more of the remaining functioning battery strings to the dynamic brake grid, for one or more of the battery strings still coupled to the power supply rail, the battery management system 306, is configured to maintain or couples the battery string(s) to a load, e.g., A/C compressor, traction motor, fan, or the like, of the locomotive to dissipate at least a portion of the energy stored in the at least one battery string. For example, the battery management system 306 maintains or couples the battery string 208C to the dynamic brake grid fan 126 and the traction motor 110 of FIG. 1, for example.

Only two battery modules are shown in FIG. 3 for brevity. One or more of the remaining battery modules in FIG. 2, such as the battery modules 202B, 202D, 202E, and 202F, may be similarly configured to be associated with corresponding cell monitoring units.

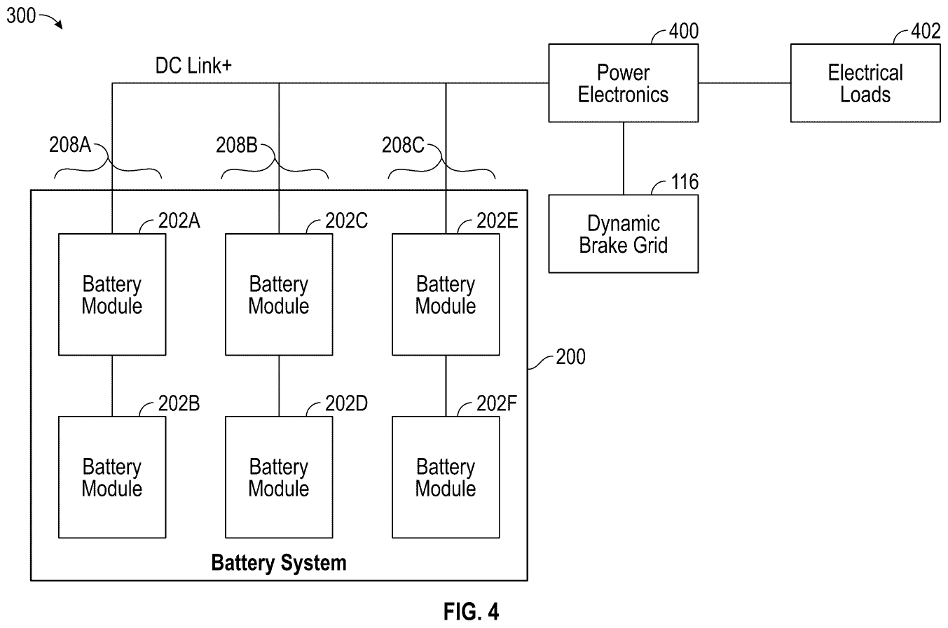

FIG. 4 is a simplified block diagram of an example of an energy discharge system 300 of FIG. 3 in combination with a load and a dynamic brake grid of a locomotive. that may implement various techniques of this disclosure. The energy discharge system 300 is coupled with power electronics 400, which may include a DC-to-AC converter, such as to provide power to one or more electrical loads 402. The electrical loads 402 may include one or more fans, such as the fans described above with respect to FIG. 1, and/or an A/C compressor, and/or the AC traction motors of the locomotive, such as the traction motor 110 of the locomotive 100 of FIG. 1.

The power from the power supply rail, e.g., the DC Link+, is converted by the power electronics 400, which includes multiple AC and DC outputs that are supplied with varying voltages to operate the electrical loads 402 and discharge the stored energy of any remaining battery strings that the battery management system 306 of FIG. 3 did not decouple from the power supply rail, e.g., the DC Link+.

### INDUSTRIAL APPLICABILITY

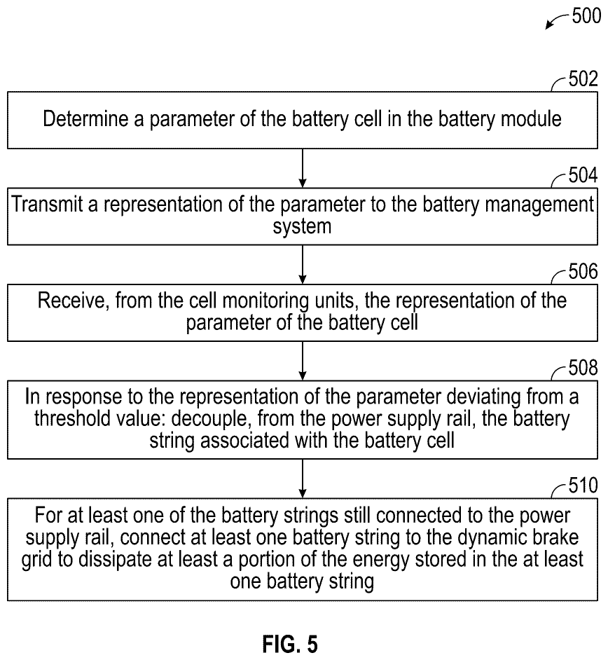

FIG. 5 is a flow diagram of an example of a method 500 for preventing thermal runaway in a locomotive in accordance with this disclosure. At block 502, the method 500 includes determining a parameter of the battery cell in the battery module. For example, the cell monitoring unit 302a of FIG. 3 determines a voltage of the battery cell 204A, where the cell monitoring unit 302 forms part of the battery system 200 of FIG. 2 that include the battery pack 118 of the locomotive 100 of FIG. 1.

At block 504, the method 500 includes transmitting a representation of the parameter to the battery management system. For example, the cell monitoring unit 302a transmits data representing the voltage of the battery cell 204A to the battery management system 306.

At block 506, the method 500 includes receiving, from the cell monitoring units, the representation of the parameter of the battery cell. For example, the battery management system 306 receives the data representing the voltage of the battery cell 204A.

At block 508, the method 500 includes in response to the representation of the parameter deviating from a threshold value: decoupling, from the power supply rail, the battery string associated with the battery cell. For example, if the battery management system 306 and, in particular, the processor 308, determines that the voltage deviates from a threshold voltage value, e.g., above or below the threshold value (as appropriate), then the battery management system 306 decouples the battery string 208A that includes the battery module 202A with the battery cell 204A from the power supply rail, e.g., the DC Link+node. This deviation in one or more parameters may signify that conditions are present for a thermal runaway process in the locomotive, such as the locomotive of FIG. 1.

At block 510, the method 500 includes for one or more of the battery strings still coupled to the power supply rail, coupling at least one battery string to the dynamic brake grid to dissipate at least a portion of the energy stored in the battery string. For example, the battery management system 306 of the energy discharge system 300 couples one or both of the battery string 208B and the battery string 208C to the dynamic brake grid 116 in FIG. 4. Discharging the battery energy into the dynamic brake grid of a locomotive, such as the locomotive of FIG. 1, will prevent cascading thermal runaway in the locomotive.

In some examples, coupling the at least one battery string to the dynamic brake grid to dissipate at least a portion of the energy stored in the at least one battery string includes selecting, based on its physical proximity to the decoupled battery string, the at least one battery string to couple to the dynamic brake grid.

In some examples, coupling the at least one battery string to the dynamic brake grid to dissipate at least a portion of the energy stored in the at least one battery string includes selecting the at least one battery string that is physically adjacent to the decoupled battery string. In some examples, the method further includes selecting any remaining battery strings still coupled to the power supply rail in an order based on their physical proximity to the decoupled battery string.

In some examples, in response to the representation of the parameter deviating from the threshold value the method includes: for at least one of the battery strings still coupled to the power supply rail, maintaining or coupling at least one battery string to a load of the locomotive to dissipate at least a portion of the energy stored in the at least one battery string.

### Various Notes

Each of the non-limiting claims or examples described herein may stand on its own, or may be combined in various permutations or combinations with one or more of the other examples.

The above detailed description includes references to the accompanying drawings, which form a part of the detailed description. The drawings show, by way of illustration, specific embodiments in which the invention may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more claims thereof), either with respect to a particular example (or one or more claims thereof), or with respect to other examples (or one or more claims thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact discs and digital video discs), magnetic cassettes, memory cards or sticks, random access memories (RAMs), read only memories (ROMs), and the like.

The above description is intended to be illustrative, and not restrictive. For example, the above-described examples (or one or more claims thereof) may be used in combination with each other. Other embodiments may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments may be combined with each other in various combinations or permutations. The scope of the invention should be determined with reference to the appended claims, along with the full scope of equivalents to which such claims are entitled.

What is claimed is:

1. An energy discharge system for preventing thermal runaway in a locomotive, wherein the locomotive has a dynamic brake grid including at least one resistor bank, the energy discharge system comprising:
a plurality of battery strings coupled with a power supply rail, wherein each battery string includes a battery module having a battery cell;
a plurality of cell monitoring units associated with corresponding battery modules;
a battery management system in communication with the plurality of cell monitoring units,
wherein the cell monitoring units are configured for:
determining a parameter of the battery cell in the battery module;
transmitting a representation of the parameter to the battery management system; and
wherein the battery management system is configured for:
receiving, from the cell monitoring units, the representation of the parameter of the battery cell; and
in response to the representation of the parameter deviating from a threshold value:
decoupling, from the power supply rail, the battery string associated with the battery cell; and
for at least one of the battery strings still coupled to the power supply rail, coupling the at least one battery string to the dynamic brake grid to dissipate at least a portion of the energy stored in the at least one battery string.

2. The energy discharge system of claim 1, wherein coupling the at least one battery string to the dynamic brake grid to dissipate at least a portion of the energy stored in the at least one battery string includes:
selecting, based on its physical proximity to the decoupled battery string, the at least one battery string to couple to the dynamic brake grid.

3. The energy discharge system of claim 1, wherein coupling the at least one battery string to the dynamic brake grid to dissipate at least a portion of the energy stored in the at least one battery string includes:
selecting the at least one battery string that is physically adjacent to the decoupled battery string.

4. The energy discharge system of claim 3, wherein the battery management system is further configured for:
selecting any remaining battery strings still coupled to the power supply rail in an order based on their physical proximity to the decoupled battery string.

5. The energy discharge system of claim 1, wherein the battery management system is further configured for:
in response to the representation of the parameter deviating from the threshold value:
for at least one of the battery strings still coupled to the power supply rail, maintaining or coupling at least one battery string to a load of the locomotive to dissipate at least a portion of the energy stored in the at least one battery string.

6. The energy discharge system of claim 5, wherein the load includes a traction motor.

7. The energy discharge system of claim 1, wherein the parameter includes one or more of a temperature, a voltage, or a current.

8. The energy discharge system of claim 1, wherein decoupling, from the power supply rail, the battery string associated with the battery cell where the representation of the parameter deviates from the threshold value includes:
determining a difference between the representation of the parameter of the battery cell in a first one of the battery modules and a representation of the parameter of a battery cell in a second one of the battery modules; and
determining whether the difference deviates from the threshold value.

9. A method for preventing thermal runaway in a locomotive, wherein the locomotive has a dynamic brake grid including at least one resistor bank, wherein the locomotive has a battery system including a plurality of battery strings coupled with a power supply rail, wherein each battery string includes a battery module having a battery cell, a plurality of cell monitoring units associated with a corresponding battery module, and a battery management system in communication with the plurality of cell monitoring units, the method comprising:
determining a parameter of the battery cell in the battery module;
transmitting a representation of the parameter to the battery management system;
receiving, from the cell monitoring units, the representation of the parameter of the battery cell; and
in response to the representation of the parameter deviating from a threshold value:
decoupling, from the power supply rail, the battery string associated with the battery cell; and
for at least one of the battery strings still coupled to the power supply rail, coupling at least one battery string to the dynamic brake grid to dissipate at least a portion of the energy stored in the at least one battery string.

10. The method of claim 9, wherein coupling the at least one battery string to the dynamic brake grid to dissipate at least a portion of the energy stored in the at least one battery string includes:
selecting, based on its physical proximity to the decoupled battery string, the at least one battery string to couple to the dynamic brake grid.

11. The method of claim 9, wherein coupling the at least one battery string to the dynamic brake grid to dissipate at least a portion of the energy stored in the at least one battery string includes:
selecting the at least one battery string that is physically adjacent to the decoupled battery string.

12. The method of claim 11, comprising:
selecting any remaining battery strings still coupled to the power supply rail in an order based on their physical proximity to the decoupled battery string.

13. The method of claim 9, comprising:
in response to the representation of the parameter deviating from the threshold value:
for at least one of the battery strings still coupled to the power supply rail, maintaining or coupling at least one battery string to a load of the locomotive to dissipate at least a portion of the energy stored in the at least one battery string.

14. The method of claim 13, wherein the load includes a traction motor.

15. The method of claim 9, wherein the parameter includes one or more of a temperature, a voltage, or a current.

16. An energy discharge system for preventing thermal runaway in a locomotive, wherein the locomotive has a dynamic brake grid including at least one resistor bank, the energy discharge system comprising:
a plurality of battery strings coupled with a power supply rail, wherein each battery string includes a battery module having a battery cell;
a plurality of cell monitoring units associated with corresponding battery modules;
a battery management system in communication with the plurality of cell monitoring units, wherein the battery management system is configured for:
receiving, from the cell monitoring units, a representation of a parameter of the battery cell; and
in response to the representation of the parameter deviating from a threshold value:
decoupling, from the power supply rail, the battery string associated with the battery cell; and
for at least one of the battery strings still coupled to the power supply rail, coupling the at least one battery string to the dynamic brake grid to dissipate at least a portion of the energy stored in the at least one battery string.

17. The energy discharge system of claim 16, wherein coupling the at least one battery string to the dynamic brake grid to dissipate at least a portion of the energy stored in the at least one battery string includes:
selecting, based on its physical proximity to the decoupled battery string, the at least one battery string to couple to the dynamic brake grid.

18. The energy discharge system of claim 16, wherein coupling the at least one battery string to the dynamic brake grid to dissipate at least a portion of the energy stored in the at least one battery string includes:
selecting the at least one battery string that is physically adjacent to the decoupled battery string.

19. The energy discharge system of claim 18, wherein the battery management system is further configured for:
selecting any remaining battery strings still coupled to the power supply rail in an order based on their physical proximity to the decoupled battery string.

20. The energy discharge system of claim 16, wherein the battery management system is further configured for:
in response to the representation of the parameter deviating from the threshold value:
for at least one of the battery strings still coupled to the power supply rail, maintaining or coupling at least one battery string to a load of the locomotive to dissipate at least a portion of the energy stored in the at least one battery string.
